(19) United States
(12) Patent Application Publication
(10) Pub. No.: US 2023/0043927 A1
(43) Pub. Date: Feb. 9, 2023

(54) Container Saddle

(71) Applicant: Chuanqi LIU, Foshan (CN)

(72) Inventor: Chuanqi LIU, Foshan (CN)

(21) Appl. No.: 17/394,368

(22) Filed: Aug. 4, 2021

(51) Int. Cl. B62J 9/14; B62J 1/00

(52) U.S. Cl. CPC B62J 9/14; B62J 1/002

(57) ABSTRACT

A container saddle includes a saddle member and a mounting arrangement provided at the saddle member for mounting the saddle member at a riding apparatus such as seated vehicle. The saddle member includes a seat base having a storage compartment, and a seat cover, having a top seating surface, selectively coupled to an upper side of the seat base between an opened position to expose the storage compartment and a closed position to enclose the storage compartment.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a bicycle saddle, and more particularly to a container saddle for a light weight seated vehicle or a seated exercise machine such as exercise bike, row-n-ride machine, rowing machine and etc., which comprises a built-in storage for storing personal items.

### Description of Related Arts

Light weight seated vehicles, such as bicycles, seated scooters, or seated razors, are light weight, compact and environmentally friendly vehicle that are very popular in both urban district and rural area. These vehicles are easy to ride and is not expensive, and have been considered as a form of transportation, recreation, and exercise. A bicycle, as an example of the seated vehicle, comprises a bicycle frame and a bicycle saddle, also known as bicycle seat, attached to a seat post of the bicycle frame for enabling a rider to sit on the bicycle saddle in order to ride the bicycle.

The bicycle saddle generally comprises a seating body and a mounting frame mounted at a bottom of the seating body, such that the bicycle saddle can be mounted at the seat post of the bicycle frame via the mounting frame to enable the rider sitting on the seating body. Accordingly, there are two types of bicycle saddle, wherein one type is the performance saddle designed for road bikes and touring bikes, and another type is the cushioning saddle designed for recreational cycling and cruising. However, the existing bicycle saddles have several drawbacks.

The bicycle saddle only provides one single function of allowing the rider to sit on the bicycle saddle during riding the bicycle. For example, the rider must carry a storage bag when riding the bicycle in order to store the personal items, such as wallet and keys. It is worth mentioning that such personal items should not be put into a pocket of the pant during riding the bicycle because these personal items will interfere the pedaling movement of the rider. Therefore, the rider must carry a carrying bag for storing the personal items, wherein the carrying bag can either worn by the rider to held at the bicycle frame. It is a burden for the rider to carry the carrying bag while the rider may loss the carrying bag held at the bicycle frame during riding the bicycle.

In order to provide an additional safety feature for the bicycle, the rider may add a reflector to the bicycle to alert another road user during riding the bicycle. The reflector is usually attached on a rear end of the bicycle frame or a rear side of the bicycle saddle. These reflectors can only reflect the light from other vehicles. In other words, the existing bicycle saddle does not provide any built-in safety device.

In addition, a seated exercise machine such as exercise bike, row-n-ride machine, or rowing machine, etc. is constructed for a user to do exercise while seating on a saddle. Especially, for a rider doing exercise in a public gym, a secured storage is needed to place his or her personal items while riding and exercising.

### SUMMARY OF THE PRESENT INVENTION

The invention is advantageous in that it provides a container saddle for a riding apparatus such as a light weight seated vehicle or a seated exercise machine, which comprises a built-in storage for storing personal items.

Another advantage of the invention is to provide a container saddle for a riding apparatus such as a light weight seated vehicle or a seated exercise machine, which is a single seating device adapted to incorporate with any existing seated vehicle, such as bicycle, seated scooter, or seated razor, or seated exercise machine, such as exercise bike, row-n-ride machine, or rowing machine.

Another advantage of the invention is to provide a container saddle for a riding apparatus such as a light weight seated vehicle or a seated exercise machine, wherein the container saddle comprises a seat base and a seat cover to define a storage compartment therebetween for storing a personal item in the storage compartment.

Another advantage of the invention is to provide a container saddle for a riding apparatus such as a light weight seated vehicle or a seated exercise machine, wherein the container saddle has a storage compartment for storing a personal item therein and providing a power unit therein to selectively supplying power to the personal item stored in the storage compartment or other electronic device(s) mounted on the light weight seated vehicle.

Another advantage of the invention is to provide a container saddle for a riding apparatus such as a light weight seated vehicle or a seated exercise machine, wherein the seat cover provides multiple functions of providing a seating surface to well support the rider during riding the seated vehicle or seated machine and selectively enclosing the storage compartment to secure the personal item therein.

Another advantage of the invention is to provide a container saddle for a riding apparatus such as a light weight seated vehicle or a seated exercise machine, wherein the storage compartment is enclosed by the seat cover during an operation of the seated vehicle or seated machine to ensure the personal item being saved in the storage compartment.

Another advantage of the invention is to provide a container saddle for a riding apparatus such as a light weight seated vehicle or a seated exercise machine, wherein the seat cover is pivotally connected to the seat base, such that the storage compartment can be exposed when the seat cover is pivotally unfolded from the seat base and can be enclosed when the seat cover is pivotally folded from the seat base.

Another advantage of the invention is to provide a container saddle for a riding apparatus such as a light weight seated vehicle or a seated exercise machine, wherein the operation of the container saddle is simple and easy to use by pivotally folding the seat cover at the seat base.

Another advantage of the invention is to provide a container saddle for a riding apparatus such as a light weight seated vehicle, wherein the container saddle comprises a built-in safety device to alert another road user during riding the seated vehicle.

Another advantage of the invention is to provide a container saddle for a riding apparatus such as a light weight seated vehicle or a seated exercise machine, which does not require to alter the original structural design of the saddle structure so as to minimize the manufacturing cost of the container saddle incorporating with the seated vehicle.

Another advantage of the invention is to provide a container saddle for a riding apparatus such as a light weight seated vehicle or a seated exercise machine, wherein no expensive or complicated mechanism is required to employ in the container saddle, so that the present invention successfully provides an economic and efficient solution not only for providing a well support of a saddle configuration but also for creating a storage space to store any personal item.

Additional advantages and features of the invention will become apparent from the description which follows, and may be realized by means of the instrumentalities and combinations particular point out in the appended claims.

According to the present invention, the foregoing and other objects and advantages are attained by a container saddle for a riding apparatus, comprising:

a saddle member which comprises:

a seat base having an upper side, a bottom side and a storage compartment formed at the upper side; and

a seat cover, having a top seating surface, selectively coupled to the upper side of the seat base between an opened position to expose the storage compartment and a closed position to enclose the storage compartment; and

a mounting arrangement provided at the bottom side of the seat base for mounting the saddle member at the riding apparatus.

In one embodiment, the container saddle further comprises at least one power unit mounted in the storage compartment for supplying power to one or more electronic devices stored in the storage compartment or mounted on the riding apparatus such as a seated vehicle.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a container saddle at a closed position according to a preferred embodiment of the present invention.

FIG. 2 is a perspective view of the container saddle at an opened position according to the above preferred embodiment of the present invention.

FIG. 3 is a sectional view of the container saddle at the closed position according to the above preferred embodiment of the present invention.

FIG. 4 is a sectional view of the container saddle at the opened position according to the above preferred embodiment of the present invention.

FIG. 5 is a rear view of the container saddle at the closed position according to the above preferred embodiment of the present invention.

FIG. 6 is a bottom view of the container saddle according to the above preferred embodiment of the present invention.

FIG. 7 is a perspective view of a functional module of the container saddle according to the above preferred embodiment of the present invention.

FIG. 8 is a perspective view of the container saddle mounted on a bicycle according to the above preferred embodiment of the present invention.

FIG. 9 is a block diagram illustrating the functional module of the container saddle according to the above preferred embodiment of the present invention.

### DETAILED DESCRIPTION OF THE PREFERRED EMBODIMENT

The following description is disclosed to enable any person skilled in the art to make and use the present invention. Preferred embodiment is provided in the following description only as examples and modifications will be apparent to those skilled in the art. The general principles defined in the following description would be applied to other embodiments, alternatives, modifications, equivalents, and applications without departing from the spirit and scope of the present invention.

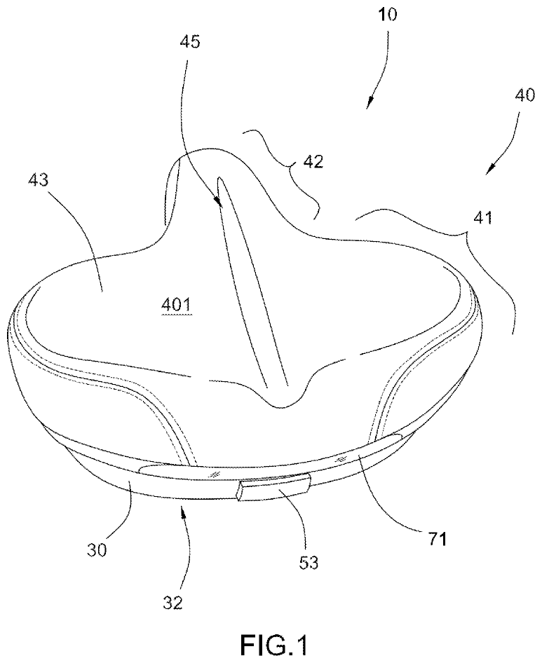

Referring to FIGS. 1 to 6, a container saddle according to a preferred embodiment of the present invention is illustrated, wherein the container saddle is adapted for mounting to a riding apparatus, such as a seated vehicle, for example bicycle, seated scooter, or seated razor, or a seated exercise machine, for example exercise bike, row-n-ride machine, or rowing machine. The container saddle, according to the preferred embodiment, comprises a saddle member 10 and a mounting arrangement 20 provided at the saddle member 10 for mounting the saddle member 10 at the riding apparatus. In one example, the container saddle of the present invention is embodied as a bicycle saddle mounted at a bicycle.

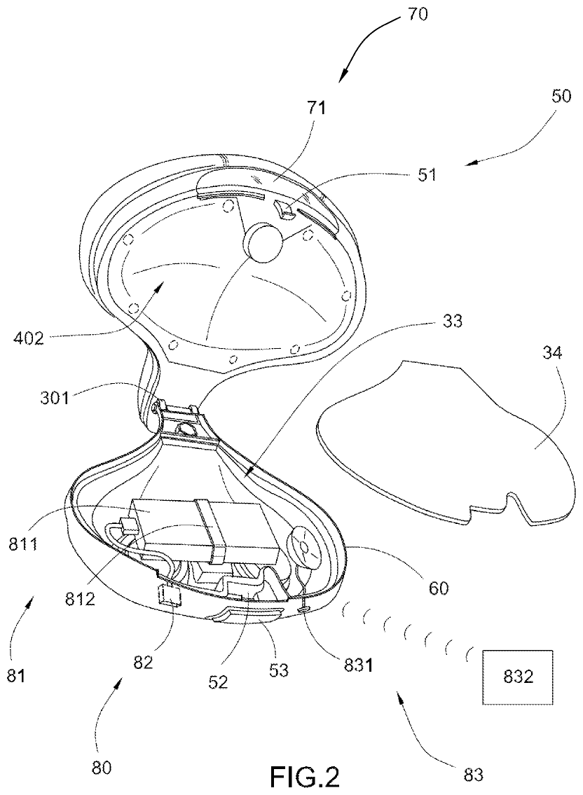

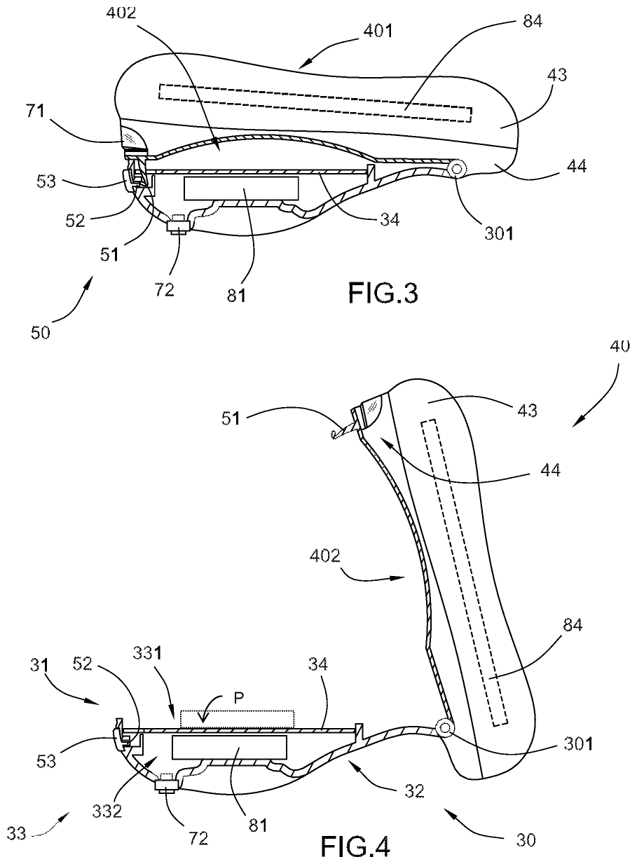

According to the preferred embodiment, the saddle member 10 comprises a seat base 30 and a seat cover 40. The seat base 30 has an upper side 31, a bottom side 32 and a storage compartment 33 formed at the upper side 31. The seat cover 40, having a top seating surface 401, is selectively coupled to the upper side 31 of the seat base 30, wherein the seat cover 40 is moved between an opened position and a closed position. At the opened position, as shown in FIGS. 1 and 3, the seat cover 40 is moved to expose the storage compartment 33 and at the closed position, as shown in FIGS. 2 and 4, the seat cover 40 is moved to enclose the storage compartment 33.

As shown in FIG. 2, the seat base 30 has a bowl-shaped configuration and is made of rigid material, wherein the storage compartment 33 is indented on the upper side 31 of the seat base 30 for storing one or more personal items, such as wallet, keys or coins. It is worth mentioning that an opening rim of the storage compartment 33 is formed at a peripheral edge portion of the upper side 31 of the seat base 30. Preferably, a peripheral wall of the seat base 30 is an inclined wall extended from the upper side 31 to the bottom side 32, such that a size of the upper side 31 of the seat base 30 is larger than a size of the bottom side 32 thereof. Preferably, the seat base 30 has an anti-skidding surface formed at a bottom wall of the storage compartment 33 to retain the personal items in position.

The seat cover 40 has a widen rear portion 41 and a narrow front portion 42 integrally and frontwardly extended therefrom. Particularly, the seat cover 40 comprises an upper cushioning body 43 defining the seating surface 401 thereon, and a lower covering body 44 to couple at the seat base 30. Accordingly, the lower covering body 44 is made of rigid material to form a hard case for supporting the upper cushioning body 43. Therefore, the rider is able to sit on the upper cushioning body 43 when riding the seated vehicle. The seat cover 40 further has an indented channel 45 indented on the seating surface 401 of the upper cushioning body 43 to define two buttock supports at a position that the indented channel 45 is positioned between the two buttock supports. In other words, when the rider sits on the upper cushioning body 43 of the saddle member 10, two buttocks of the rider are supported on the buttock supports of the upper cushioning body 43 while the narrow front portion 42 of the seat cover 40 is extended between the thighs of the rider, wherein the indented channel 45 is designed to reduce pressure to the perineum of the rider.

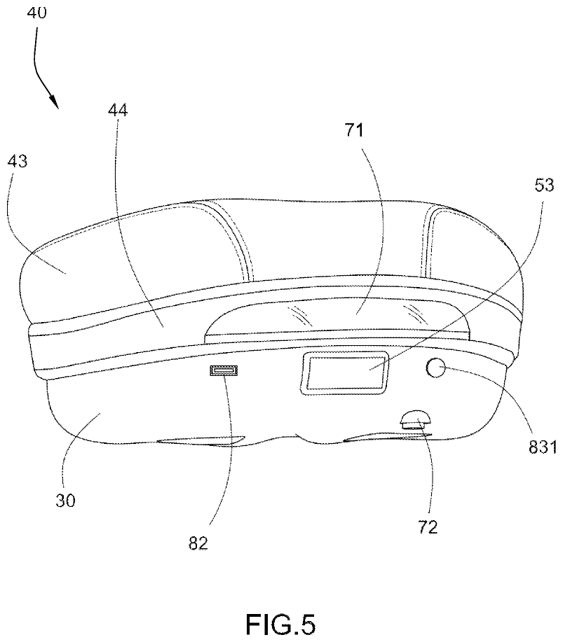

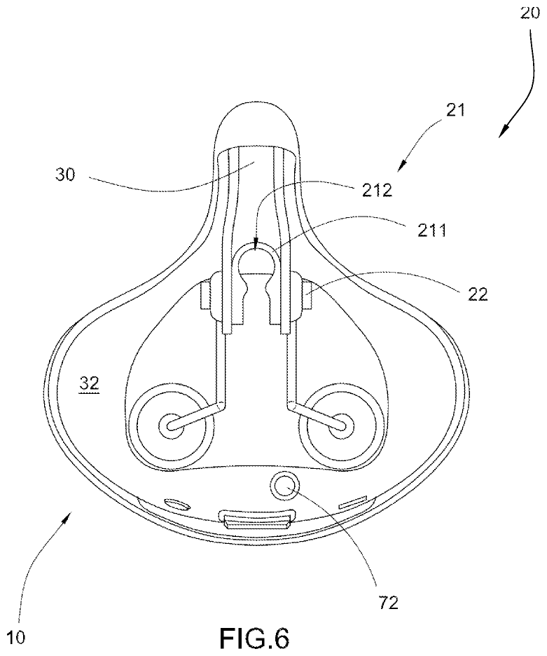

As shown in FIG. 5, a width of the upper cushioning body 43 is larger than a width of the lower covering body 44. The width of the lower covering body 44 is larger than a width of the seat base 30. Therefore, the seat cover 40 serves as a shelter to prevent any dust or water entering into the storage compartment 33 from the seat cover 40.

As shown in FIGS. 3 and 4, the seat cover 40 further has an indented cavity 402 formed at the bottom side thereof to communicate with the storage compartment 33 for enlarging a size of the storage compartment 33 when the seat cover 40 is moved at the closed position. Therefore, the storage space of the saddle member 10 will be enlarged by the overall space of the storage compartment 33 and the indented cavity 402. In other words, the storage compartment 33 is able to store the personal item, such as an electronic device (mobile phone) or a power unit (rechargeable power bank), having a height slightly larger than a depth of the storage compartment 33.

In one embodiment, the seat cover 40 is pivotally coupled to the seat base 30 via a pivot joint 301, such that the seat cover 40 is pivotally moved between the opened position and the closed. In other words, at the opened position, the seat cover 40 is pivotally and upwardly moved from the seat base 30 to expose the storage compartment 33. At the closed position, the seat cover 40 is pivotally and downwardly moved to the seat base 30 to enclose the storage compartment 33.

As shown in FIGS. 3 and 4, the pivot joint 301 is provided at a front portion of the saddle member 10. Particularly, the pivot joint 301 is provided at the narrow front portion 42 of the seat cover 40 at a bottom side thereof to pivotally couple at a front end of the seat base 30. Therefore, at the opened position, as shown in FIG. 4, the seat cover is pivotally, upwardly and frontward moved from the seat base 30 to expose the storage compartment 33. At the closed position, as shown in FIG. 3, the seat cover 40 is pivotally, downwardly and rearwardly moved to the seat base 30 to enclose the storage compartment 33. In other words, the pivot joint 301 is pivotally connected between the narrow front portion 42 of the lower covering body 44 at the bottom side thereof and the front end of the seat base 30 at the upper side thereof.

It is worth mentioning that when the rider sits on the seat cover 40, the weight of the rider will apply on the seat cover 40 to ensure the seat cover 40 at the closed position. Furthermore, when the rider sits on the seat cover 40, the weight of the rider will apply on the widen rear portion 41 of the seat cover 40 to prevent the seat cover 40 being accidentally folded from the closed position to the opened position.

According to the preferred embodiment, the saddle member 10 further comprises a locking arrangement 50 that locks up the seat cover 40 at the closed position. In one embodiment, the locking arrangement 50 comprises a first locking member 51 provided at the seat cover 40, a second locking member 52 provided at the seat base 30 to releasably lock up to the first locking member 51, and an actuation button 53 provided at the seat base 30 for being pressed to release a locking engagement between the first and second locking members 51, 52 so as to enable the seat cover 40 being moved from the closed position to the opened position.

Accordingly, the first locking member 51 is embodied as a latch provided at the bottom side of the lower covering body 44 at the rear side thereof. Correspondingly, the second locking member 52 is embodied as a catch provided at the upper side 31 of the seat base 30 at the rear side thereof. At the locked position, the seat cover 40 is moved to the seat base 30 until the first and second locking members 51, 52 are interlocked with each other so as to lock up the seat cover 40 at the closed position. In order to unlock the seat cover 40, the actuation button 53 is pressed to actuate and move the second locking member 52 from being disengage with the first locking member 51, such that the seat cover 40 is able to fold from the closed position to the opened position. Preferably, the pivot joint 301 is incorporated with a spring-loaded mechanism, such that when the actuation button 53 is pressed to disengage the second locking member 52 with the first locking member 51, the seat cover 40 is automatically moved from the closed position to the opened position via the spring-loaded mechanism of the pivot joint 301.

Preferably, the saddle member further comprises a sealing element 60 encircling around the opening rim of the storage compartment 33 to seal with the seat cover 40 at the closed position. In other words, at the closed position, the sealing element 60 is sealed between the seat base 30 and the seat cover 40 to prevent any water or moisture entering into the storage compartment 33. In other words, the storage compartment 33 is considered as a waterproof compartment. Preferably, a first sealing channel is formed around the opening rim of the storage compartment 33 and a second sealing channel is formed around peripheral edge portion of the seat cover 40, i.e. a rim of the indented cavity 402. The sealing element 60 is disposed at the first sealing channel, wherein at the closed position, the sealing element 60 is sealed at the first and second channels to seal the indented cavity 402 and the storage compartment 33.

According to the preferred embodiment of the present invention, the seat base 30 further comprises a partition panel 34 detachably disposed in the storage compartment 33 to divide the storage compartment 33 into an upper compartment portion 331 and a lower compartment portion 332, wherein the lower compartment portion 332 of the storage compartment 33 is enclosed by the partition panel 34. The upper compartment portion 331 of the storage compartment 33 is exposed when the seat cover 40 is moved at the opened position. Accordingly, the portable battery 811 and the fastener device 812.

According to the preferred embodiment, the saddle container further comprises an alert device 70 which is a built-in device thereof. In one embodiment, the alert device 70 comprises a battery-powered illuminating unit 71 provided at a rear side of the seat cover 40 and a control switch 72 provided at the bottom side 32 of the seat base 30 to control an operation of the illuminating unit 71.

Accordingly, the illuminating unit 71 is embodied as a LED (Light Emitting Diode) illuminator provided at the rear side of the lower covering body 44 for generating different light patterns. In one example, the illuminating unit 71 is constructed to have an illuminating panel mounted at the rear side of the lower covering body 44 to enclose one or more LEDs therein. The control switch 72 is embodied as a press button provided at the bottom side 32 of the seat base 30 at the rear portion thereof, wherein the control switch 72 can be reached and pressed when the rider sits on the seat cover 40. When the control switch 72 is initially pressed, the illuminating unit 71 is powered on to generate a first light pattern, such as illumination effect. When the control switch 72 is pressed again, the illuminating unit 71 is activated to generate a second light pattern, such as flashing light. When the control switch 72 is pressed at the third time, the illuminating unit 71 is powered off. It is worth mentioning that the illuminating unit 71 can generate different light colors for achieving different alert purposes.

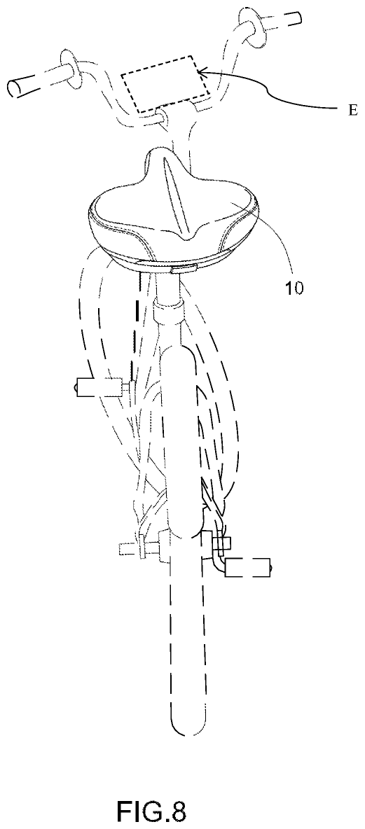

In one embodiment, as shown in FIGS. 6 and 8, the container saddle of the present invention is embodied as the bicycle saddle, wherein the mounting arrangement 20 is designed to mount to a seat post of the bicycle. According to the preferred embodiment, the mounting arrangement 20 comprises a post mount 21 adapted for mounting at the seat post of the bicycle as the seated vehicle, and a tilt adjustor 22 that is configured to adjust a tilt position of the saddle member 10 with respect to the seat post. The post mount 21 comprises a mounting frame 211 coupled at the bottom side 32 of the seat base 30 and a post socket 212 coupled at the mounting frame 211 for securely mounting to the seat post. The tilt adjustor 22 is embodied as a pivot hinge pivotally coupling the post socket 212 at the mounting frame 211, such that when the seat post of the bicycle is coupled at the post socket 212, the tilt position of the saddle member 10 can be selectively adjusted by pivotally moving the post socket 212 with respect to the mounting frame 211.

In another example, the container saddle of the present invention can be coupled to an electric scooter having a seat post. The mounting configuration for the electric scooter is the same as that for the bicycle.

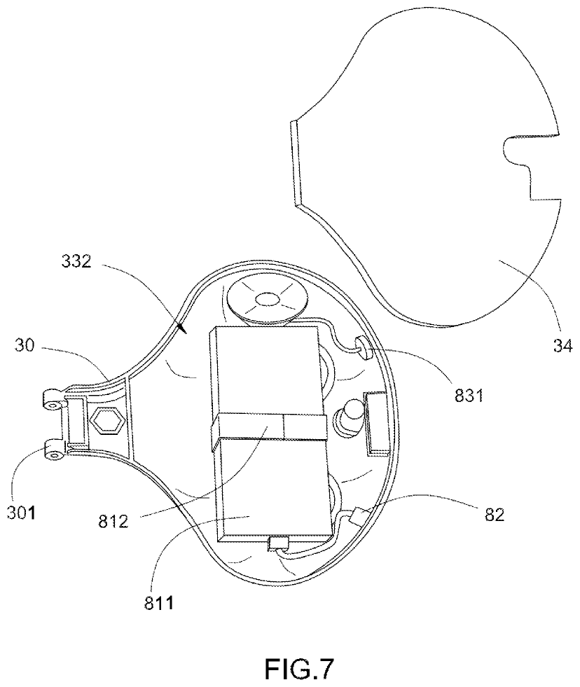

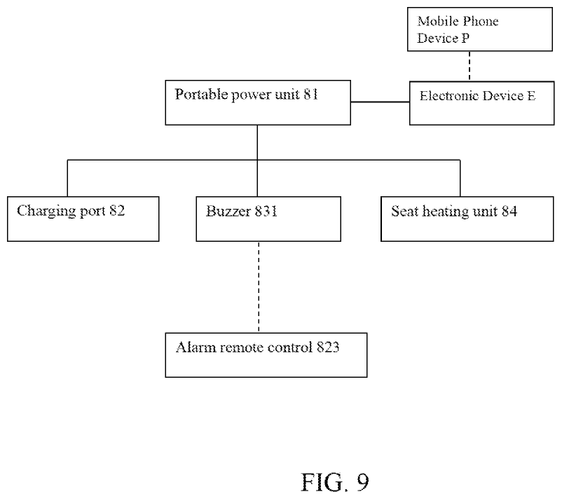

As shown in FIGS. 7 and 9, the container saddle further comprises a functional module 80 disposed in the storage compartment 33 for providing additional function. The functional module 80 comprises a power unit 81 secured in the storage compartment 33, and a charging port 82 which is provided at the bottom side 32 of the seat base 30 and electrically connected to the portable power unit 81 for electrically charging an external electronic device. According to the preferred embodiment of the present invention, the power unit 81 comprises a portable battery 811 and a fastener device 812 provided extended from the bottom wall of the storage compartment 33 to detachably fasten the portable battery 811 at the storage compartment 33. In one embodiment, the fastener device 812 is embodied as two hook and loop strips extended from the bottom wall of the storage compartment 33 and detachably fastened with each other to form a fastening loop to secure the portable battery 811 in the storage compartment 33 so as to prevent any unwanted vibration of the portable battery 811 in the storage compartment 33 when riding the bicycle or the like. It is worth mentioning that the portable battery 811 can be removed from the storage compartment 33 and recharged to ensure the fully charged power supply of the portable battery 811. It is worth mentioning that the illuminating unit 71 can be powered by its own power battery or by the portable battery 811. The charging port 82, such as a USB port as an example, is electrically connected to the portable battery 811 via a cable, and is provided at the bottom side 32 of the seat base 30, wherein the user is able to electrically charge the external electronic device, such as mobile phone, without opening the seat cover 40. As shown in FIG. 8, one or more external electronic devices E, such as a speaker, monitor, tablet, or display screen, can be mounted on the light weight vehicle, wherein the power unit 81 is configured to be electrically connected with the external electronic device E to supply power thereto.

It is appreciated that the user may also secure his or her mobile phone P with the fastener device 812 instead of the portable battery 811 so as to store his or her mobile phone in a secure manner during riding the vehicle. If the external electronic device E is mounted on the vehicle, it is preferred to be electrically connected with the container saddle of the present invention so that the user may still access the useful information such as mapping and navigation, audio signals of his or her mobile phone through the one or more external electronic device E (e.g. display screen and speaker) while the one or more external electronic device E is electrically and communicatively connected with the mobile phone through the container saddle of the present invention.

Alternatively, in addition to the portable battery 811 secured by the fastener device 812, as shown in FIG. 4, the user's mobile electronic device, for example the mobile phone P, can also be fastened with the battery 811 by the fastener device 812 together, wherein portable battery 811 is preferred to be electrically connected with the mobile phone P to charge the phone while it is stored in the storage compartment 33. Similarly, the mobile phone P is also able to be stored in upper compartment portion 331 and secured on the partition panel 34 and electrically connected with the portable battery 811 for phone charging during the storage. Furthermore, the mobile phone P stored the storage compartment is capable of electrically connecting or communicatively connecting wirely or wirelessly with the external electronic device E to display useful or selected information from the mobile phone while the user is riding the vehicle.

The functional module 80 further comprises an alarm unit 83 for providing a security function for the seated vehicle. The alarm unit 83 comprises a buzzer 831 electrically connected to the portable battery 811 of the portable power unit 81 and an alarm remote control 832 remotely arming and disarming the buzzer 831. As shown in FIGS. 2 and 7, the buzzer 831 is provided at the rear side of the seat base 30 for generating audible warning signal such as high volume sound. Accordingly, when the buzzer 831 is armed, the buzzer 831 will generate high volume sound due to unwanted movement of the seated vehicle. The alarm remote control 823 is further actuated to activate the buzzer 831 for paging the seated vehicle. Therefore, the user is able to actuate the alarm remote control 823 to activate the buzzer 831 for generating the audible warning signal in order to easily search the seated vehicle. The buzzer 831 is preferred to be located at the lower compartment portion 332 of the storage compartment 33 and are enclosed by the partition panel 34.

In one embodiment, the buzzer 831 can be embodied as a speaker that is able to play music from the external electronic device. For example, the buzzer 831 can be a “Bluetooth” speaker or other wireless connected speakers adapted for wirelessly connecting to the external electronic device, such that the user is able to play the music from the external electronic device via the buzzer 831.

The functional module 80 further comprises a seat heating unit 84 electrically connected to the portable battery 811 of the portable power unit 81 for warming the upper cushioning body 43. Accordingly, the seat heating unit 84 comprises a heating element, such as a resistor, embedded in the upper cushioning body 43, such that when the seat heating unit 84 is powered on, the seat heating unit 84 will generate heat to warm the top seating surface 401 of the upper cushioning body 43 of the seat cover 40.

One skilled in the art will understand that the embodiment of the present invention as shown in the drawings and described above is exemplary only and not intended to be limiting.

It will thus be seen that the objects of the present invention have been fully and effectively accomplished. The embodiment has been shown and described for the purposes of illustrating the functional and structural principles of the present invention and is subject to change without departure from such principles. Therefore, this invention includes all modifications encompassed within the spirit and scope of the following claims.

What is claimed is:

1. A container saddle for a riding apparatus, comprising:
a saddle member which comprises:
a seat base having an upper side, a bottom side and a storage compartment formed at said upper side; and
a seat cover, having a top seating surface, selectively coupled to said upper side of said seat base between an opened position to expose said storage compartment and a closed position to enclose said storage compartment; and
a mounting arrangement provided at said bottom side of said seat base for mounting said saddle member at the riding apparatus.

2. The container saddle, as recited in claim 1, wherein said seat cover is pivotally coupled to said seat base via a pivot joint, such that at said opened position, said seat cover is pivotally and upwardly moved from said seat base to expose said storage compartment and at said closed position, said seat cover is pivotally and downwardly moved to said seat base to enclose said storage compartment.

3. The container saddle, as recited in claim 2, wherein said seat cover has a widen rear portion and a narrow front portion integrally extended therefrom, wherein said pivot joint is provided at said narrow front portion of said seat cover at a bottom side thereof to pivotally couple at a front end of said seat base, such that at said opened position, said seat cover is pivotally, upwardly and frontward moved from said seat base to expose said storage compartment and at said closed position, said seat cover is pivotally, downwardly and rearwardly moved to said seat base to enclose said storage compartment.

4. The container saddle, as recited in claim 1, wherein said seat cover further has an indented cavity formed at a bottom side thereof to communicate with said storage compartment for enlarging a size of said storage compartment when said seat cover is moved at said closed position.

5. The container saddle, as recited in claim 3, wherein said seat cover further has an indented cavity formed at a bottom side thereof to communicate with said storage compartment for enlarging a size of said storage compartment when said seat cover is moved at said closed position.

6. The container saddle, as recited in claim 1, wherein said seat cover comprises an upper cushioning body defining said seating surface thereon, and a lower covering body to couple at said seat base, wherein a width of said upper cushioning body is larger than a width of said lower covering body.

7. The container saddle, as recited in claim 5, wherein said seat cover comprises an upper cushioning body defining said seating surface thereon, and a lower covering body to couple at said seat base, wherein a width of said upper cushioning body is larger than a width of said lower covering body.

8. The container saddle, as recited in claim 6, wherein said width of said lower covering body is larger than a width of said seat base.

9. The container saddle, as recited in claim 7, wherein said width of said lower covering body is larger than a width of said seat base.

10. The container saddle, as recited in claim 6, wherein said seat cover further has an indented channel indented on said seating surface of said upper cushioning body to define two buttock supports at a position that said indented channel is positioned between said two buttock supports.

11. The container saddle, as recited in claim 9, wherein said seat cover further has an indented channel indented on said seating surface of said upper cushioning body to define two buttock supports at a position that said indented channel is positioned between said two buttock supports.

12. The container saddle, as recited in claim 1, wherein said saddle member further comprises a locking arrangement that locks up said seat cover at said closed position, wherein said locking arrangement comprises a first locking member provided at said seat cover, a second locking member provided at said seat base to releasably lock up to said first locking member, and an actuation button provided at said seat base for being pressed to release a locking engagement between said first and second locking members so as to enable said seat cover being moved from said closed position to said opened position.

13. The container saddle, as recited in claim 11, wherein said saddle member further comprises a locking arrangement that locks up said seat cover at said closed position, wherein said locking arrangement comprises a first locking member provided at said seat cover, a second locking member provided at said seat base to releasably lock up to said first locking member, and an actuation button provided at said seat base for being pressed to release a locking engagement between said first and second locking members so as to enable said seat cover being moved from said closed position to said opened position.

14. The container saddle, as recited in claim 12, wherein said first locking member is provided at a rear side of said seat cover, while said second locking member and said actuation button are provided at a rear side of said seat base.

15. The container saddle, as recited in claim 13, wherein said first locking member is provided at a rear side of said seat cover, while said second locking member and said actuation button are provided at a rear side of said seat base.

16. The container saddle, as recited in claim 1, wherein said saddle member further comprises a sealing element encircling around an opening rim of said storage compartment to seal with said seat cover at said closed position.

17. The container saddle, as recited in claim 15, wherein said saddle member further comprises a sealing element encircling around an opening rim of said storage compartment to seal with said seat cover at said closed position.

18. The container saddle, as recited in claim 1, further comprising an alert device which comprises a battery-powered illuminating unit provided at a rear side of said seat cover and a control switch provided at said bottom side of said seat base to control an operation of said illuminating unit.

19. The container saddle, as recited in claim 17, further comprising an alert device which comprises a battery-powered illuminating unit provided at a rear side of said seat cover and a control switch provided at said bottom side of said seat base to control an operation of said illuminating unit.

20. The container saddle, as recited in claim 1, wherein said mounting arrangement comprises a post mount adapted for mounting at a seat post of a bicycle as the seated vehicle, and a tilt adjustor configured to adjust a tilt position of said saddle member with respect to the seat post.

21. The container saddle, as recited in claim 1, further comprising a portable power unit secured in said storage compartment, and a charging port provided at said bottom side of said seat base, wherein said charging port is electrically connected to said portable power unit for electrically charging an external electronic device without opening said seat cover.

22. The container saddle, as recited in claim 21, wherein said portable power unit comprises a portable battery and a fastener device provided extended from a bottom wall of said storage compartment to detachably fasten said portable battery at said storage compartment.

23. The container saddle, as recited in claim 22, further comprising an alarm unit which comprises a buzzer electrically connected to said portable battery of said portable power unit and an alarm remote control remotely arming and disarming said buzzer, wherein said buzzer is provided at said bottom side of said seat base for generating audible warning signal.

24. The container saddle, as recited in claim 23, further comprising a seat heating unit electrically connected to said portable battery of said portable power unit for warming said top seating surface of said seat cover.

25. The container saddle, as recited in claim 24, wherein said seat base further comprises a partition panel detachably disposed in said storage compartment to divide said storage compartment into an upper compartment portion and a lower compartment portion, wherein said lower compartment portion is enclosed by said partition panel, wherein said portable battery, said fastener device, and said buzzer are located at said lower compartment portion of said storage compartment and are enclosed by said partition panel.
